(19) United States
(12) Patent Application Publication
(10) Pub. No.: US 2012/0213260 A1
(43) Pub. Date: Aug. 23, 2012

(54) Discrete Spurious Leakage Cancellation for Use in a Cable Modem

(75) Inventors: Boris Froimovich, Netanya (IL); Oren Ben-Hamo, Rehovot (IL); Shaul Klein, Herzelia (IL)

(73) Assignee: TEXAS INSTRUMENTS INCORPORATED, Dallas, TX (US)

(21) Appl. No.: 13/439,163

(22) Filed: Apr. 4, 2012

Related U.S. Application Data
(62) Division of application No. 12/426,424, filed on Apr. 20, 2009.

(51) Int. Cl. H04B 1/38

(52) U.S. Cl. 375/222

(57) ABSTRACT

In a novel apparatus for and method of discrete spurious frequency leakage cancellation a radio frequency RF switch is used to couple the upstream path signal to the CATV cable only during transmission bursts. In between transmission bursts, the upstream signal is disconnected from the CATV cable. In a circuit for canceling frequency spurs from a victim signal, a radio frequency (RF) switch is operative to connect and disconnect the victim signal to/from the output in accordance with a switch control signal which is generated by a switch control module. The victim signal is coupled to said RF switch output during transmission bursts only.

### CROSS REFERENCE TO RELATED APPLICATIONS

This application is a Divisional of and claims priority to U.S. Nonprovisional patent application No. 12/426,424 filed Apr. 20, 2009, hereby incorporated by reference herein in its entirety.

### FIELD

The present invention relates to the field of data communications and more particularly relates to a discrete spurious frequency leakage cancellation method and apparatus for use in a cable modem such as a Data Over Cable Service Interface Specification (DOCSIS) compliant cable modem.

### BACKGROUND

Currently there are more than 50 million high-speed Internet access customers in North America. Recently, the cable modem has become the broadband connection of choice for many Internet users, being preferred over the nearest rival broadband technology, Digital Subscriber Line (DSL), by a significant margin.

Cable modems are well known in the art. A cable modem is a type of modem that provides access to a data signal sent over the cable television (CATV) infrastructure. Cable modems are primarily used to deliver broadband Internet access, taking advantage of unused bandwidth on a cable television network. In 2005 there were over 22.5 million cable modem users in the United States alone.

A cable modem is a network appliance that enables high speed data connections to the internet via data services provided by the local cable company. Data from the home is sent upstream on a carrier that operates on the 5 MHz to 42 MHz band of the cable spectrum. Downstream data is carried on a 88 MHz to 860 MHz band. The cable modem system can have additional networking features such as Voice over IP (VoIP), wireless connectivity or network switch or hub functionality.

The term cable Internet access refers to the delivery of Internet service over the cable television infrastructure. The proliferation of cable modems, along with DSL technology, has enabled broadband Internet access in many countries. The bandwidth of cable modem service typically ranges from 3 Mbps up to 40 Mbps or more. The upstream bandwidth on residential cable modem service usually ranges from 384 kbps to 30 Mbps or more. In comparison, DSL tends to offer less speed and more variance between service packages and prices. Service quality is also far more dependent on the client's location in relation to the telephone company's nearest central office or Remote Terminal.

Users in a neighborhood share the available bandwidth provided by a single coaxial cable line. Therefore, connection speed varies depending on how many people are using the service at the same time. In most areas this has been eliminated due to redundancy and fiber networks.

With the advent of Voice over IP telephony, cable modems are also being used to provide telephone service. Many people who have cable modems have opted to eliminate their Plain Old Telephone Service (POTS). An alternative to cable modems is the Embedded Multimedia Terminal Adapter (EMTA). An EMTA allows multiple service operators (MSOs) to offer both High Speed Internet and VoIP through a single piece of customer premise equipment. A multiple system operator is an operator of multiple cable television systems.

Many cable companies have launched Voice over Internet Protocol (VoIP) phone service, or digital phone service, providing consumers a true alternative to standard telephone service. Digital phone service takes the analog audio signals and converts them to digital data that can be transmitted over the fiber optic network of the cable company. Cable digital phone service is currently available to the majority of U.S. homes with a large number of homes are now subscribing. The number of homes subscribing is currently growing by hundreds of thousands each quarter. One significant benefit of digital phone service is the substantial consumer savings, with one recent study saying residential cable telephone consumers could save an average of $135 or more each year.

The Data Over Cable Service Interface Specification (DOCSIS) compliant cable modems have been fueling the transition of cable television operators from a traditional core business of entertainment programming to a position as full-service providers of video, voice, and data telecommunications services.

Cable systems transmit digital data signals over radio frequency (RF) carrier signals. To provide two-way communication, one carrier signal carries data in the downstream direction from the cable network to the customer and another carrier signal carries data in the upstream direction from the customer to the cable network. Cable modems are devices located at the subscriber premises that functions to convert digital information into a modulated RF signal in the upstream direction, and to convert the RF signals to digital information in the downstream direction. A cable modem termination system (CMTS) performs the opposite operation for multiple subscribers at the cable operator's head-end.

Typically, several hundreds of users share a 6 MHz downstream channel and one or more upstream channels. The downstream channel occupies the space of a single television transmission channel in the cable operator's channel lineup. It is compatible with digital set top MPEG transport stream modulation (64 or 256 QAM), and provides up to 40 Mbps. A media access control (MAC) layer coordinates shared access to the upstream bandwidth.

The DOCSIS 2.0 specification provides for both more efficient modulation techniques and increased RF channel bandwidth in the return path under two different allowed multi-access protocols: a time division multi-access (TDMA) protocol and a synchronous code division multi-access (S-CDMA) protocol. Under the DOCSIS 2.0 TDMA protocol, the maximum allowed RF channel bandwidth is increased from 3.2 to 6.4 MHz and three new higher-order modulation techniques are specified: 8 QAM, 32 QAM, and 64 QAM. As a result, the maximum raw data rate is increased from 10.24 Mbps in the case of DOCSIS 1.0/1.1 (16 QAM in 3.2 MHz) to 30.72 Mbps (64 QAM in 6.4 MHz).

Under TDMA, individual channel users are assigned a distinct time slot during which they transmit a QAM burst that encodes multiple information bits. Under CDMA, the in-phase and quadrature (I and Q) components of each QAM symbol are first encoded into a stream of sub-bits, or ‘chips’. Each user is assigned one or more distinct code chip sequences that are recognized by a matched correlator at the receiver that rejects all other users' code sequences. In this manner, multiple users are able to transmit simultaneously in the same time slot. The DOCSIS S-CDMA protocol is actually a time division multiplexed CDMA that employs 128-chip spreading codes and mini-time slots spanning multiple CDMA symbols.

A potential problem in the design of cable modems is spurious emissions from signal leakage from the PHY circuitry into the upstream path. Out of band spurious emissions can be filtered out relatively easily. In-band spurious emissions, however, are more difficult to eliminate.

In accordance with the DOCSIS 2.0 specification, the spurious emissions specifications are separated into two regions based on the transmit power. Region 1 is defined to have a power range of +14 dBmV to (Pmax−3), i.e. the central region. Region 2 is defined from +8 dBmV to +14 dBmV and (Pmax−3) to Pmax, i.e. the low and high ends of the transmit power.

For S-CDMA mode, when a modem is transmitting fewer than four spreading codes, the region 2 specifications are used for all transmit power levels. Otherwise, for all other numbers of spreading codes (e.g., 4 to 128) or for TDMA mode, the spurious emissions specifications are used according to the power ranges defined for regions 1 and 2 above.

The noise and spurious power cannot exceed the levels given in Table 1 below.

TABLE 1
DOCSIS 2.0 Spurious Emissions

| Parameter | Transmitting Burst | Between Bursts |
|---|---|---|
| Inband | −40 dBc | The greater of −72 dBc |
| | | or −59 dBmV |
| Adjacent Band | See Table 6-10 | The greater of −72 dBc |
| | | or −59 dBmV |
| 3 or Fewer Carrier- | Region 1: −50 dBc | The greater of −72 dBc |
| Related Frequency | for transmitted | or −59 dBmV |
| Bands (such as second | modulation | |
| harmonic, if < 42 MHz) | rate = 320 ksps and | |
| | above; −47 dBc for | |
| | transmitted | |
| | modulation | |
| | rate = 160 ksps | |
| | Region 2: −47 dBc | |
| Bands within 5 to 42 | See Table 6-11 | The greater of −72 dBc |
| MHz (excluding | | or −59 dBmV |
| assigned channel, | | |
| adjacent channels, and | | |
| carrier-related channels) | | |
| CM Integrated Spurious | | |
| Emissions Limits | | |
| (all in 4 MHz, | | |
| includes discretes)¹ | | |
| 42 to 54 MHz | max (−40 dBc, | −26 dBmV |
| | −26 dBmV) | |
| 54 to 60 MHz | −35 dBmV | −40 dBmV |
| 60 to 88 MHz | −40 dBmV | −40 dBmV |
| 88- to 860 MHz | −45 dBmV | max (−45 dBmV, |
| | | −40 dB ref d/s²) |
| CM Discrete Spurious | | |
| Emissions Limits¹ | | |
| 42 to 54 MHz | −max (−50 dBc, | −36 dBmV |
| | −36 dBmV) | |
| 54 to 88 MHz | −50 dBmV | −50 dBmV |
| 88 to 860 MHz | −50 dBmV | −50 dBmV |

In Table 1 above, in-band spurious emissions may include noise, carrier leakage, clock signal lines, synthesizer spurious products and other undesired transmitter products. The measurement bandwidth for in-band spurious is equal to the modulation rate (e.g., 160 to 5120 kHz). All requirements expressed in dBc are relative to the actual transmit power that the cable modem emits.

The measurement bandwidth for the three (or fewer) Carrier-Related Frequency Bands (below 42 MHz) is 160 kHz, with up to three 160 kHz bands, each with no more than the value given in Table 1, allowed to be excluded from the “Bands within 5 to 42 MHz Transmitting Burst” specifications of Table 2 below. Carrier-related spurious emissions include all products whose frequency is a function of the carrier frequency of the upstream transmission, such as but not limited to carrier harmonics. The measurement bandwidth is also 160 kHz for the Between Bursts specifications of Table 1 below 42 MHz.

The Transmitting Burst specifications apply during the mini-slots granted to the cable modem (when the cable modem uses all or a portion of the grant), and for 32 modulation intervals before and after the granted mini-slots. The Between Bursts specifications apply except during a used grant of mini-slots, and the 32 modulation intervals before and after the used grant.

In TDMA mode, a mini-slot may be as short as 32 modulation intervals, or 6.25 microseconds at the 5.12 Msymbol/sec rate, or as short as 200 microseconds at the 160 ksym/sec rate.

TABLE 2
Spurious Emissions in 5 to 42 MHz Relative to the Transmitted Burst
Power Level

| Possible | Specification | Specification | Initial measurement |
|---|---|---|---|
| modulation rate | in the interval, | in the interval, | interval and distance |
| in this interval | Region 1 | Region 2 | from carrier edge |
| 160 kHz | −54 dBc | −53 dBc | 220 kHz to 380 kHz |
| 320 kHz | −52 dBc | −50 dBc | 240 kHz to 560 kHz |
| 640 kHz | −50 dBc | −47 dBc | 280 kHz to 920 kHz |
| 1280 kHz | −48 dBc | −44 dBc | 360 kHz to 1640 kHz |
| 2560 kHz | −46 dBc | −41 dBc | 520 kHz to 3080 kHz |
| 5120 kHz | −44 dBc | −38 dBc | 840 kHz to 5960 kHz |

In the worst case, the maximum spurious level relative to the transmission level permitted during transmission is −54 dBc. Spurious emissions, other than those in an adjacent channel or carrier related emissions listed above, may occur in intervals (frequency bands) that could be occupied by other carriers of the same or different modulation rates. To accommodate these different modulation rates and associated bandwidths, the spurious emissions are measured in an interval equal to the bandwidth corresponding to the modulation rate of the carrier that could be transmitted in that interval. This interval is independent of the current transmitted modulation rate.

Table 2 above lists the possible modulation rates that could be transmitted in an interval, the required spurious level in that interval, and the initial measurement interval at which to start measuring the spurious emissions. Typically, the modulation is set by the CMTS utilizing the downstream link.

For example, consider a 35 MHz clock used to drive a cable modem PHY that leaks to the output of a PGA circuit output at a sufficiently high magnitude to cause a violation of the DOCSIS in-band spurious level specifications. The magnitude of the leakage will typically vary by the particular PCB payout used and the configuration of the 1.5 V decoupling capacitors.

In the worst case, for DOCSIS 2.0 for bands within 5 to 42 MHz, the maximum allowed spurious emissions between transmission bursts is -59 dBmV which translates to approximately −107.75 dBm or 1.122 μV on 75 ohm. A spur emitted at 35 MHz (PHY clock driver) cannot be filtered because is falls within the upstream frequency range of 5 to 42 MHz.

One approach to solving this problem is to modify the design of the PHY circuit which may be a complex, FPGA or ASIC. A disadvantage of this approach is complicated and very expensive process (in terms of human resources) of analyzing and investigating the circuit to find the leakage path. Therefore, in the case of in-band spurious emissions (e.g., noise, carrier leakage, clock signal lines, synthesizer spurious products, etc.), a mechanism is needed to substantially minimize or cancel the spurious emissions. The mechanism should meet the requirements of the DOCSIS cable modem specification and operate efficiently, be of low complexity, exhibit high performance, consume minimal board and chip area and be able to be manufactured at low cost.

### SUMMARY

The present invention is a novel apparatus for and method of discrete spurious frequency leakage cancellation for use in a cable modem. The spurious leakage cancellation mechanism is particularly suitable for use in cable modem systems adapted to implement the DOCSIS 2.0 specification which specifies both downstream and upstream channels.

In one embodiment, the spurious emission cancellation mechanism cancels the spurious emissions by first creating a replica of the aggressor clock signal having the same amplitude but 180 degree phase shift as the spurious signal. The phase shifted spurious replica is added to the original spurious signal thus cancelling the spurious signal.

In another embodiment, an RF switch is used to couple the upstream path signal to the CATV cable only during transmission bursts. In between transmission bursts, the upstream signal is disconnected from the CATV cable. This embodiment takes advantage of the less stringent spurious requirements in the DOCSIS 2.0 specification for transmission bursts. In between transmission bursts, when stricter spurious requirements apply, the upstream signal is disconnected from the CATV cable.

To aid in understanding the principles of the present invention, the description is provided in the context of a DOCSIS 2.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any transmission circuit wherein it is desirable to cancel or substantially eliminate in-band spurious emissions.

Several advantages of the discrete spurious leakage cancellation mechanism of the present invention include (1) relatively low cost of manufacturing; (2) stable circuit operation over temperature and voltage fluctuations; (3) simple and clear implementation to satisfy users and customers; (4) relatively to implement; and (5) can be removed from the cable modem circuit design without requiring changes to the PCB layout.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the present invention, a circuit for canceling frequency spurs from a victim signal, the frequency spurs originating from an aggressor clock source comprising a canceling clock source for generating a canceling clock signal, a conditioning circuit operative to generate an amplitude and phase adjusted cancellation signal from the canceling clock source and combining means for applying the cancellation signal to the victim signal thereby substantially canceling the frequency spurs.

There is also provided in accordance with the present invention, a method of canceling frequency spurs from a victim signal, the frequency spurs originating from an aggressor clock source, the method comprising the steps of providing a canceling clock source for generating a canceling clock signal, conditioning the canceling clock signal to generate an amplitude and phase adjusted cancellation signal therefrom and combining the cancellation signal with the victim signal to generate an output signal having substantially reduced frequency spur energy.

There is further provided in accordance with the present invention, a cable modem connected to a Community Antenna Television (CATV) infrastructure comprising a memory, one or more interface ports, a downstream path including a tuner, an upstream path for generating an upstream signal to be transmitted over the CATV infrastructure, the upstream path comprising a canceling clock source for generating a canceling clock signal, a conditioning circuit operative to generate an amplitude and phase adjusted cancellation signal from the canceling clock source, combining means for applying the cancellation signal to the upstream signal thereby substantially canceling the frequency spurs, a PHY circuit coupled to the downstream path and the upstream path and a processor coupled to the memory, the one or more interface ports and the PHY circuit, the processor operative to implement a media access control (MAC) layer operative to generate an output video stream.

There is also provided in accordance with the present invention, a circuit for canceling frequency spurs from a victim signal, the frequency spurs derived from an aggressor clock source comprising a radio frequency (RF) switch having an output and operative to connect and disconnect the victim signal to the output in accordance with a switch control signal and a switch control module operative to generate the switch control signal, wherein the victim signal is coupled to the RF switch output during transmission bursts only.

There is further provided in accordance with the present invention, a method of canceling frequency spurs from a victim signal, the frequency spurs originating from an aggressor clock source, the method comprising the steps of providing a radio frequency (RF) switch having an output and operative to connect and disconnect the victim signal to the output in accordance with a switch control signal and generating the switch control signal whereby the victim signal is coupled to the RF switch output during transmission bursts only.

There is also provided in accordance with the present invention, a cable modem connected to a Community Antenna Television (CATV) infrastructure comprising a memory, one or more interface ports, a downstream path including a tuner, an upstream path for generating an upstream signal to be transmitted over the CATV infrastructure, the upstream path including a radio frequency (RF) switch having an output and operative to connect and disconnect the upstream signal to the output in accordance with a switch control signal, a PHY circuit coupled to the tuner and the RF switch, the PHY circuit comprising a switch control module operative to generate the switch control signal, wherein the upstream signal is coupled to the RF switch output during transmission bursts only and a processor coupled to the memory, the one or more interface ports and the PHY circuit, the processor operative to implement a media access control (MAC) layer operative to generate an output video stream.

### BRIEF DESCRIPTION OF THE DRAWINGS

The invention is herein described, by way of example only, with reference to the accompanying drawings, wherein:

FIG. 1 is a block diagram illustrating an example cable modem system incorporating the upstream system of the present invention;

FIG. 2 is a block diagram illustrating an example cable modem including an upstream system incorporating the spur reduction mechanism of the present invention;

FIG. 3 is a simplified block diagram illustrating the processor of the cable modem of FIG. 2 including an upstream system incorporating a first embodiment of the spur reduction mechanism of the present invention;

FIG. 4 is a schematic diagram illustrating the spur cancellation circuit of FIG. 3 in more detail;

FIG. 5 is a block diagram illustrating a model of a portion of the upstream circuit without the spur cancellation mechanism of the present invention;

FIG. 6 is a block diagram illustrating a model of a portion of the upstream circuit incorporating the spur cancellation mechanism of the present invention;

FIG. 7 is a spectrum plot illustrating frequency response of the spur cancellation circuits of FIGS. 5 and 6;

FIG. 8 is a time domain plot of the spur without the spur cancellation mechanism of the present invention;

FIG. 9 is a frequency spectrum of the spur of FIG. 8;

FIG. 10 is a time domain plot of the spur with the spur cancellation mechanism of the present invention;

FIG. 11 is a frequency spectrum of the spur of FIG. 10; and

FIG. 12 is a simplified block diagram illustrating the processor of the cable modem of FIG. 2 including an upstream system incorporating a second embodiment of the spur reduction mechanism of the present invention;

### DETAILED DESCRIPTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| ATM | Asynchronous Transfer Mode |
| CATV | Community Antenna Television or Cable TV |
| CDMA | Code Division Multiple Access |
| CM | Cable Modem |
| CMTS | Cable Modem Termination System |
| CO | Central Office |
| CPU | Central Processing Unit |
| DAC | Digital to Analog Converter |
| DCAS | Downloadable Conditional Access Systems |
| DECT | Digital Enhanced Cordless Telecommunications |
| DHCP | Dynamic Host Control Protocol |
| DOCSIS | Data Over Cable Service Interface Specification |
| DS | Downstream |
| DSL | Digital Subscriber Line |
| DSP | Digital Signal Processor |
| DVR | Digital Video Recorder |
| EEROM | Electrically Erasable Read Only Memory |
| EMTA | Embedded Multimedia Terminal Adapter |
| FPGA | Field Programmable Gate Array |
| GPIO | General Purpose I/O |
| HDL | Hardware Description Language |
| I/F | Interface |
| I/O | Input/Output |
| IC | Integrated Circuit |
| IP | Internet Protocol |
| LAN | Local Area Network |
| LED | Light Emitting Diode |
| MAC | Media Access Control |
| MPEG | Moving Picture Experts Group |
| MSO | Multiple Service Operator |
| NB | Narrowband |
| PC | Personal Computer |
| PC | Personal Computer |
| PCB | Printed Circuit Board |
| PCC | Passive Cancellation Circuit |
| PDA | Personal Digital Assistant |
| PGA | Programmable Gain Amplifier |
| PLL | Phase Locked Loop |
| POTS | Plain Old Telephone Service |
| PSTN | Public Switched Telephone Network |
| QAM | Quadrature Amplitude Modulation |
| RAM | Random Access Memory |
| RF | Radio Frequency |
| ROM | Read Only Memory |
| SLIC | Subscriber Line Interface Card |
| SONET | Synchronous Optical Network |
| SPDT | Single Pole Double Throw |
| TB | Tuning Band |
| TDMA | Time Division Multiple Access |
| US | Upstream |
| USB | Universal Serial Bus |
| VCO | Voltage Controlled Oscillator |
| VGA | Variable Gain Amplifier |
| VoIP | Voice over IP |
| WAN | Wide Area Network |
| WB | Wideband |
| WLAN | Wireless Local Area Network |

### DETAILED DESCRIPTION

Embodiments of the invention are a novel apparatus for and method of discrete spurious frequency leakage cancellation for use in a cable modem. The spurious leakage cancellation mechanism is particularly suitable for use in cable modem systems adapted to implement the DOCSIS 2.0 specification which specifies both downstream and upstream channels.

To aid in understanding the principles of the present invention, the description is provided in the context of a DOCSIS 2.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any transmission circuit wherein it is desirable to cancel or substantially eliminate in-band spurious emissions.

It is noted that the spur reduction mechanism of the present invention can be used in cable modems designed for use not only in North America, but also for use with the Euro DOCSIS standard using a similar configuration.

Note that throughout this document, the term communications device is defined as any apparatus or mechanism adapted to transmit, or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof.

The term cable modem is defined as a modem that provides access to a data signal sent over the cable television infrastructure. The term voice cable modem is defined as a cable modem that incorporates VoIP capabilities to provide telephone services to subscribers

### Cable System Incorporating Spur Reduction Mechanism

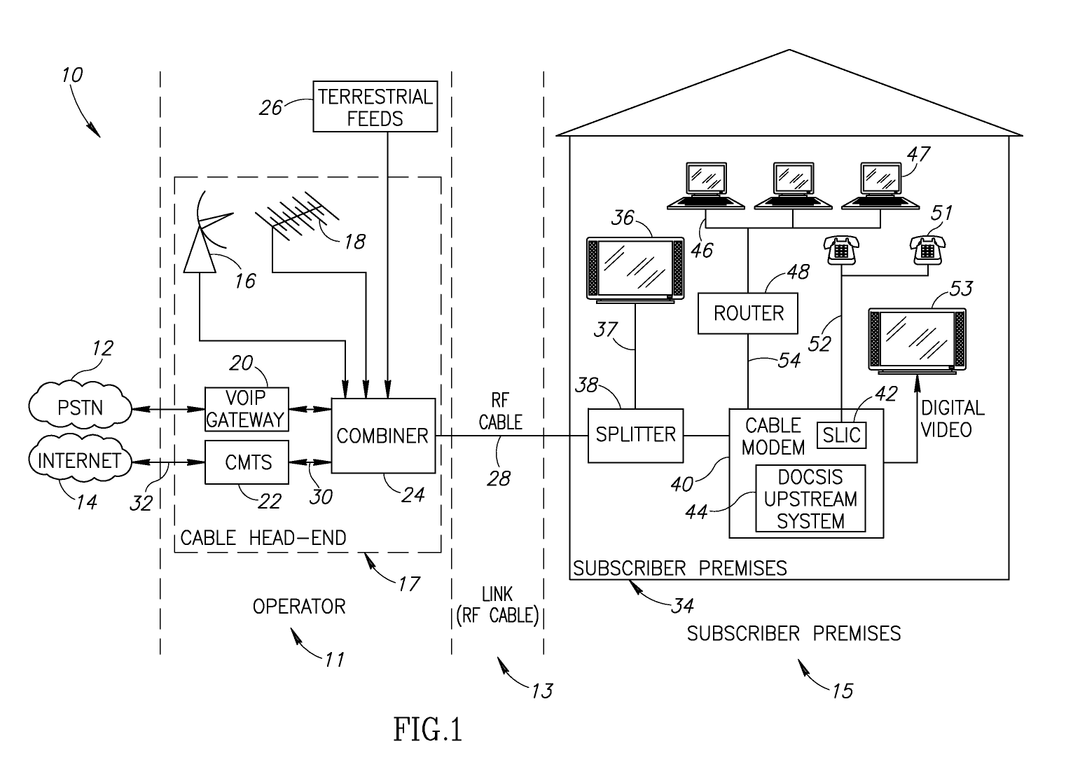

A block diagram illustrating a cable modem system incorporating the upstream system of the present invention is shown in FIG. 1. The system, generally referenced 10, comprises an operator portion 11 connected to the public switched telephone network (PSTN) 12 and the Internet 14 or other wide area network (WAN), a link portion 13 comprising the RF cable 28 and a subscriber portion 15 comprising the subscriber premises 34.

The operator portion 11 comprises the cable head-end 17 which is adapted to receive a number of content feeds such as satellite 16, local antenna 18 and terrestrial feeds 26, all of which are input to the combiner 24. The cable head-end also comprises the voice over IP (VoIP) gateway 20 and Cable Modem Termination System (CMTS) 22. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cell. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 34 comprises a splitter 38, cable appliances 36 such as televisions, DVRs, etc., cable modem 40, router 48, PCs or other networked computing devices 47 and telephone devices 51. Cable service is provided by the local cable provider wherein the cable signal originates at the cable head end facility 17 and is transmitted over RF cable 28 to the subscriber premises 34 where it enters splitter 38. One output of the splitter goes to the televisions, set top boxes, and other cable appliances via internal cable wiring 37.

The other output of the splitter comprises the data portion of the signal which is input to the cable modem 40. The cable modem is adapted to provide both Ethernet and USB ports. Typically, a router 48 is connected to the Ethernet port via Ethernet cable 54. One or more network capable computing devices 47, e.g., laptops, PDAs, desktops, etc. are connected to the router 48 via internal Ethernet network wiring 46. In addition, the router may comprise or be connected to a wireless access point that provides a wireless network (e.g., 802.11b/g/a) throughout the subscriber premises.

The cable modem also comprises a subscriber line interface card (SLIC) 42 which provides the call signaling and functions of a conventional local loop to the plurality of installed telephone devices 51 via internal 2-wire telephone wiring 52. In particular, it generates call progress tones including dial tone, ring tone, busy signals, etc. that are normally provided by the local loop from the CO. Since the telephone deices 51 are not connected to the CO, the SLIC in the cable modem must provide these signals in order that the telephone devices operate correctly.

The cable modem also comprises a downstream system (not shown) and an upstream system 44 which incorporates the spur reduction mechanism of the present invention. A digital video output signal is displayed to the user (i.e. cable subscribers) via televison set 53 (i.e. video display device or other cable appliance).

### DOCSIS 2.0 Channel Cable Modem

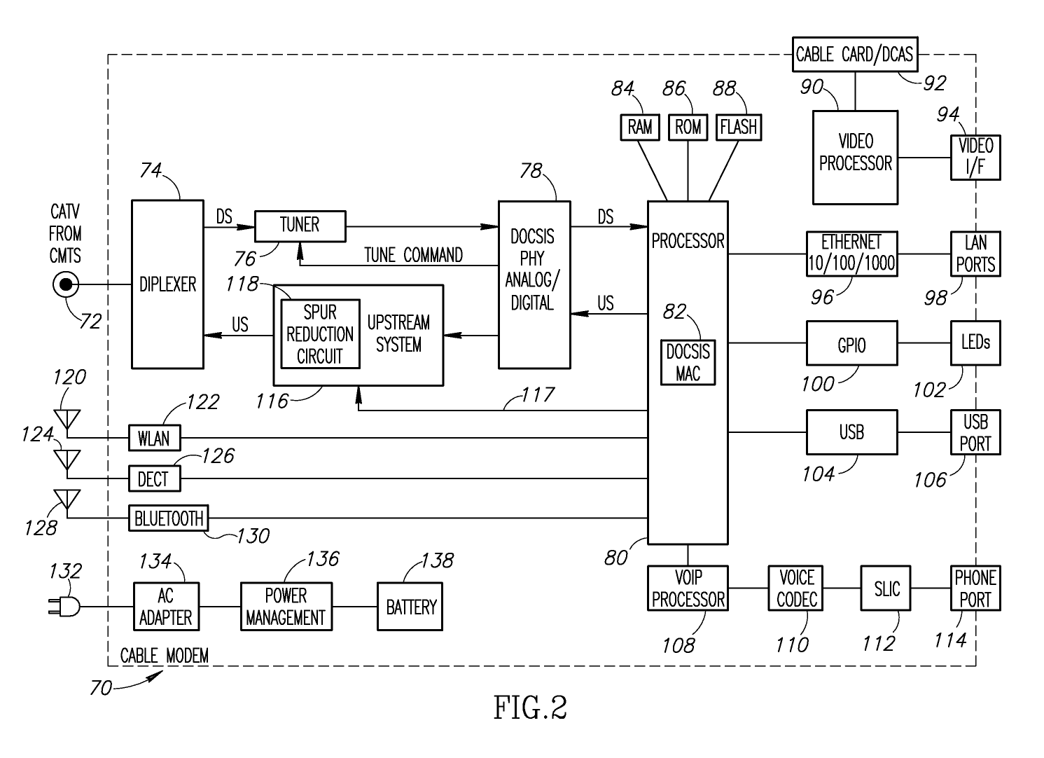

A block diagram illustrating an example cable modem including an upstream system incorporating the spur reduction mechanism of the present invention is shown in FIG. 2. The cable modem, generally referenced 70, comprises a duplexer 74, CATV RF tuner circuit 76 incorporating, DOCSIS PHY (analog/digital) 78, DOCSIS compatible processor 80, DOCSIS MAC 82, VoIP processor 108, voice codec 110, subscriber line interface card (SLIC) 112, phone port 114, wireless local area network (WLAN) 122 and associated antenna 120, DECT 126 and associated antenna 124, Bluetooth 130 and associated antenna 128, Ethernet interface 96, Ethernet LAN ports 98, general purpose (I/O) (GPIO) interface 100, LEDs 102, universal serial bus (USB) interface 104, USB port 106, cable card/Downloadable Conditional Access Systems (DCAS) 92, video interface (I/F) 94, video processor 90, upstream system 116 including spur reduction circuit 118, AC adapter 134 coupled to mains utility power via plug 132, power management circuit 136, battery 138, RAM 84, ROM 86 and FLASH memory 88.

Note that in the example embodiment presented herein, the cable modem and DOCSIS enabled processor are adapted to implement the DOCSIS 2.0 standard. Although the invention is applicable to cable modems designed to implement this standard, the invention is not limited to use therein. It can be applied to other standards and systems, and should not be limited to use in the example cable modem application presented herein.

In operation, the cable modem processor is the core chip set which in the example presented herein comprises a central single integrated circuit (IC) with peripheral functions added. The voice over IP (VoIP) processor 108 implements a mechanism to provide phone service outside the standard telco channel. Chipset DSPs and codecs 96 add the functionality of POTS service for low rate voice data.

The cable modem also comprises a subscriber line interface card (SLIC) 112 which functions to provide the signals and functions of a conventional local loop to a plurality of telephone devices connected via the phone port 114 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 VAC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 96 and Ethernet LAN port 98, USB interface 104 and USB port 106 or with additional chip sets, such as wireless 802.11a/b/g via WLAN interface 122 coupled to antenna 120. In addition, a GPIO interface 100 provides an interface for LEDs 102, etc. The network connectivity functions may also include a router or Ethernet switch core. Note that the DOCSIS MAC 82 and PHY 78 may be integrated into the cable modem processor 80 or may be separate.

In the example embodiment presented herein, the tuner 76 is coupled to the CATV signal from the CMTS via port 72 and is operative to convert the RF signal received over the RF cable to an IF frequency in accordance with the tune command signals received from the processor.

The cable modem 70 comprises a processor 80 which may comprise a digital signal processor (DSP), central processing unit (CPU), microcontroller, microprocessor, microcomputer, ASIC, FPGA core or any other suitable processing means. The cable modem also comprises static read only memory (ROM) 86, dynamic main memory 84 and FLASH memory 88 all in communication with the processor via a bus (not shown).

The magnetic or semiconductor based storage device 84 (i.e. RAM) is used for storing application programs and data. The cable modem comprises computer readable storage medium that may include any suitable memory means, including but not limited to, magnetic storage, optical storage, semiconductor volatile or non-volatile memory, biological memory devices, or any other memory storage device.

Any software required to implement the spur reduction mechanism of the present invention is adapted to reside on a computer readable medium, such as a magnetic disk within a disk drive unit. Alternatively, the computer readable medium may comprise a floppy disk, removable hard disk, Flash memory, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the spur reduction mechanism of the present invention may also reside, in whole or in part, in the static or dynamic main memories or in firmware within the processor of the computer system (i.e. within microcontroller, microprocessor or microcomputer internal memory).

### Spur Reduction Mechanism

In accordance with the invention, two solutions are presented to reduce or eliminate the spurious emission leakage problem whereby the clock (e.g., 35 MHz clock) that drives the PHY circuit leaks to the output of the PGA circuit causing the cable modem to violate DOCSIS limits on spurious emission levels.

The first embodiment for reducing the spur power level comprises a passive cancellation circuit (PCC). This circuit uses the 35 MHz PHY clock, available from a dedicated pin on the PHY integrated circuit (IC), and creates from it a modified amplitude and phase cancellation signal. This cancellation signal is applied to the single ended output of the balun before the diplexer, thereby cancelling the spur power present at that point.

The second embodiment for reducing the spur power level comprises an RF switch whereby an RF switch is inserted into the US path between the PGA's balun and diplexer. The RF switch provides wideband isolation between US transmission bursts, reducing the 35 MHz spur power, in addition to any additional power that may reside in the bandwidth of the transmitted signal.

The first embodiment is preferred due its lower cost and is the more robust solution that meets DOCSIS specifications. The second embodiment has application in cases where there is concern for additional noise injection into the RF output from the PCB assembly. Each of the embodiments will now be described in more detail.

### First Embodiment: Spur Cancellation Circuit

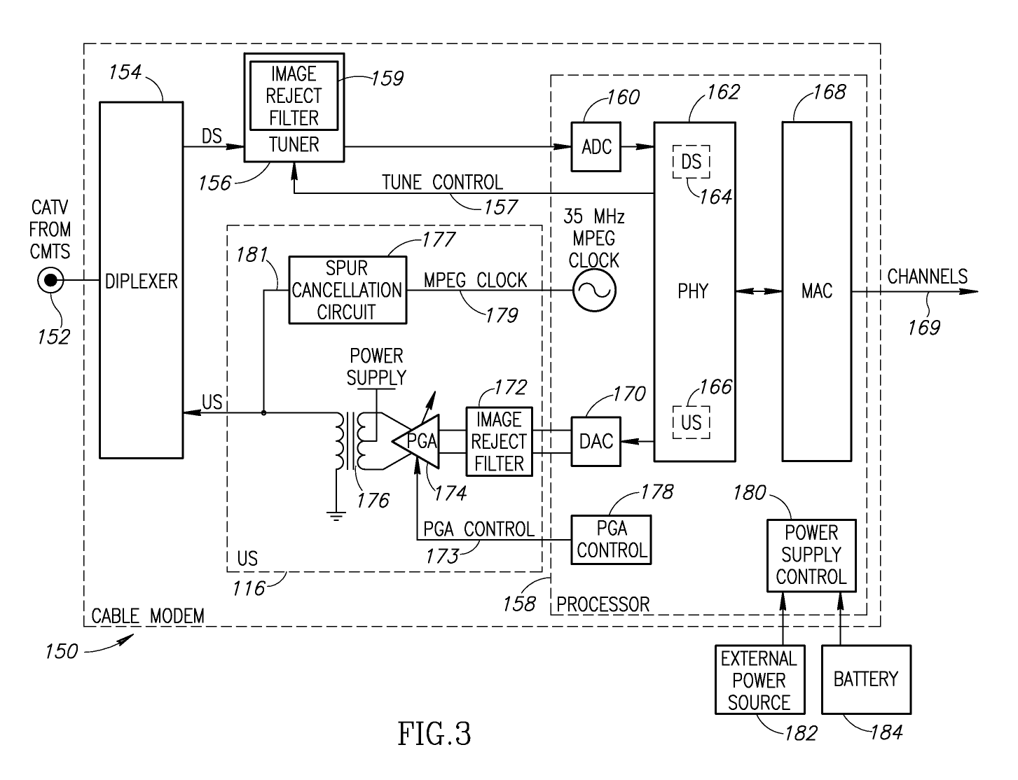

A simplified block diagram illustrating the processor of the cable modem of FIG. 2 including an upstream system incorporating a first embodiment of the spur reduction mechanism of the present invention is shown in FIG. 3. The example cable modem, generally referenced 150, comprises diplexer 154 coupled to a CATV input 152, RF tuner circuit 156, processor 158 and upstream path circuit 116.

The upstream circuit 116 comprises image reject filter 172, PGA 174, balun 176 and spur cancellation circuit 177. The processor 158 comprises an analog to digital converter (ADC) 160, PHY circuit 162, digital to analog converter (DAC) 170, PGA control circuit 178, power supply control 180 and MAC 168. Power is supplied by an external power source 182 e.g., utility power, etc. or a battery 184.

In operation, in the downstream (i.e. receive) direction, the receive signal from the diplexer is input to the CATV RF tuner circuit 156. The tuner output signal is input to the ADC to provide I and Q input signals to the PHY circuit. The PHY circuit provides a tuner control signal 157 that controls the tuning of the tuner circuit. After MAC processing, one or more MPEG video streams 169 are output of the cable modem.

In the upstream (US) (i.e. transmit) direction, a digital TX output signal provided by the PHY circuit is converted to analog by the DAC. The analog signal is then filtered via the image reject filter 172 before being amplified by the PGA whose gain is controlled by a PGA control signal 173 generated by the PGA control circuit 178.

The output of the PGA circuit is input to one side of the balun 176. The other side of the balun is input to the diplexer 154 which couples the US signal to the CATV cable 152. In accordance with the invention, spur cancellation circuit 177 functions to substantially cancel the in-band spurious emissions from the US signal before input to the diplexer.

The spur cancellation circuit is operative to adjust the amplitude and phase of the 35 MHz MPEG clock 179 such that when combined with the US signal, the spur signals are cancelled or substantially cancelled. Note that the spur cancellation circuit operates both during US transmission bursts and in between bursts. The 35 MHz MPEG clock is used to generate the cancellation signal assuming that the source of the spur is the PHY clock, which is based on the 35 MHz MPEG clock. It is appreciated that the source signal used to generate the cancellation signal is not limited to the clock shown in the example circuit presented herein but can be any clock or other signal source depending on the particular implementation of the invention.

The spur cancellation circuit 177 is essentially a passive cancellation circuit (PCC). It is based on the assumption that the interfering frequency spur is narrow band and has predictable characteristics of frequency, phase and amplitude. The 35 MHz spur that is coupled to the output path of the PGA is dependent on the particular ground separation regime implemented and the 1.5 V digital power supply decoupling capacitor arrangement. It is preferable that there be a single solid ground (including the PGA ground) and to use decoupling capacitors of 1 nF or less on the digital 1.5 V power supply network. Experiments by the inventors have shown that this configuration results in a spur level of less then −55 dBmV. Use of the spur cancellation circuit of the present invention reduces this level further.

The 35 MHz clock 179 (internal or external) is highly correlative with the DOCSIS PHY clock (which is the source of the spur). The spur cancellation circuit 177 functions to condition the amplitude and phase of the MPEG clock. After signal conditioning, the clock signal is applied to the output of the balun 176. This reduces the level of the spur to a worst case of −61 dBmV and a typical level of −7 dBmV over temperature and sample variation and +/−5% voltage changes, which translates to a 6 dB mnimum/12 dB typical improvement.

The MPEG clock output 179 is a digital 3.3 V peak-to-peak clock signal which translates to 64 dBmV. The amplitude of the cancellation signal 181 preferably should be equal to the amplitude of the spur, i.e. −55 dBmV. Thus, a relatively high attenuation of approximately 120 dB is required, The exact attenuation can be determined empirically for maximum cancellation.

The phase of the cancellation signal 181 (relative to the MPEG clock) is set empirically for maximum cancellation. Measurements have shown that a good starting point is −95 degrees.

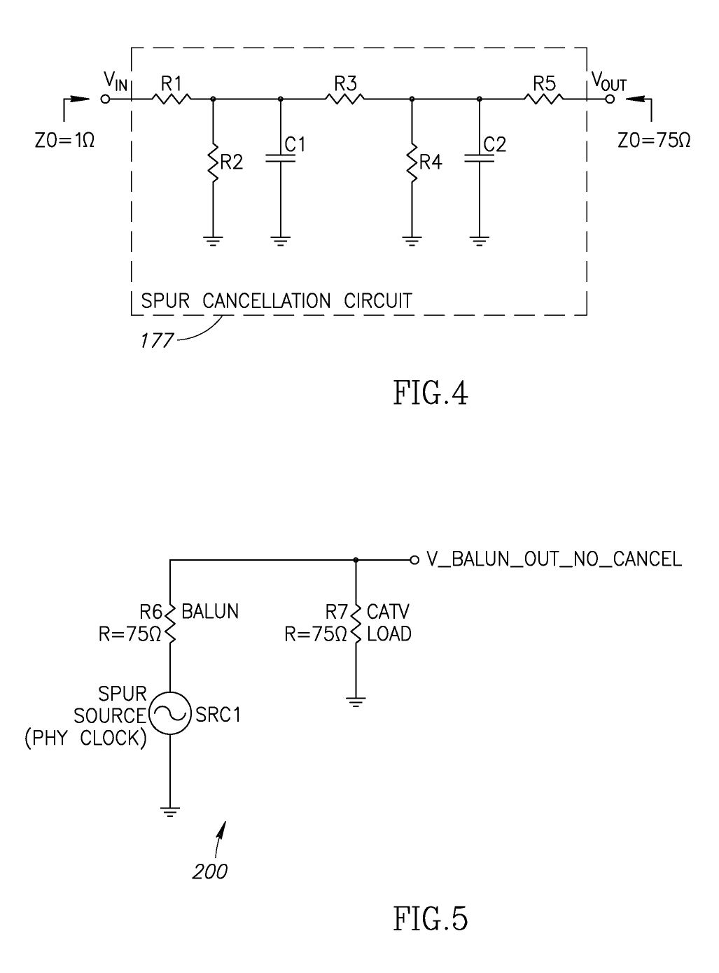

A schematic diagram illustrating the spur cancellation circuit of FIG. 3 in more detail in shown in FIG. 4. The circuit shown herein represents a preferred amplitude and phase conditioning scheme. It is appreciated that other schemes using other circuit topologies may be used to achieve similar results without departing from the scope of the invention.

The circuit, generally referenced 177, comprises resistors R1, R2, R3, R4, R5 and capacitors C1, C2. Example values of the resistor and capacitor component values for circuit 177 are given below in Table 3.

TABLE 3
Example component values

| Component | Value |
|---|---|
| R1 | 100 kOhm |
| R2 | 1000 Ohm |
| R3 | 100 kOhm |
| R4 | 1000 Ohm |
| R5 | 3320 Ohm |
| C1 | 6 pF |
| C2 | 6 pF |

The variance of the components may be configured such that its impact on the overall spur cancellation is negligible. For example, consider resistor accuracy of 1% and capacitor accuracy of 5%. Under these conditions, the component variance results in an amplitude variation of +/−0.6 dB and phase variation of +/−3 degrees. The variation in amplitude translates to a cancellation limitation of −23.5 dB and phase variation translates to a cancellation limitation of −25.62 dB. The total cancellation limitation (i.e. amplitude and phase) is −21.dB, i.e. −76 dBmV.

Note that the impedance looking into the circuit 177 is 1 Ohm. The output impedance is 75 Ohm (i.e. the characteristic impedance of the cable modem) to match the impedance of the CATV cable.

In operation, resistors R1/R2 and R3/R4 form voltage dividers which function to significantly attenuate the MPEG clock signal. Capacitors C1 and C2 function to shift the phase of the MPEG clock signal. The result is a cancellation signal having a phase opposite that of the spur. When combined to the output of the balun, the spur is reduced sufficiently to meet DOCSIS requirements.

This approach to spur reduction has several advantages, including (1) very low cost (i.e. only a few resistors and capacitors are required); (2) relatively very quick implementation; and (3) no need for external control such as is required in the case of an RF switch (second embodiment).

A block diagram illustrating a model of a portion of the upstream circuit without the spur cancellation mechanism of the present invention is shown in FIG. 5. The circuit, generally referenced 200, comprises SRC1 (the source of the spur, the PHY clock), R6 (the balun impedance) having a 75 Ohm impedance and R7 (representing the CATV load).

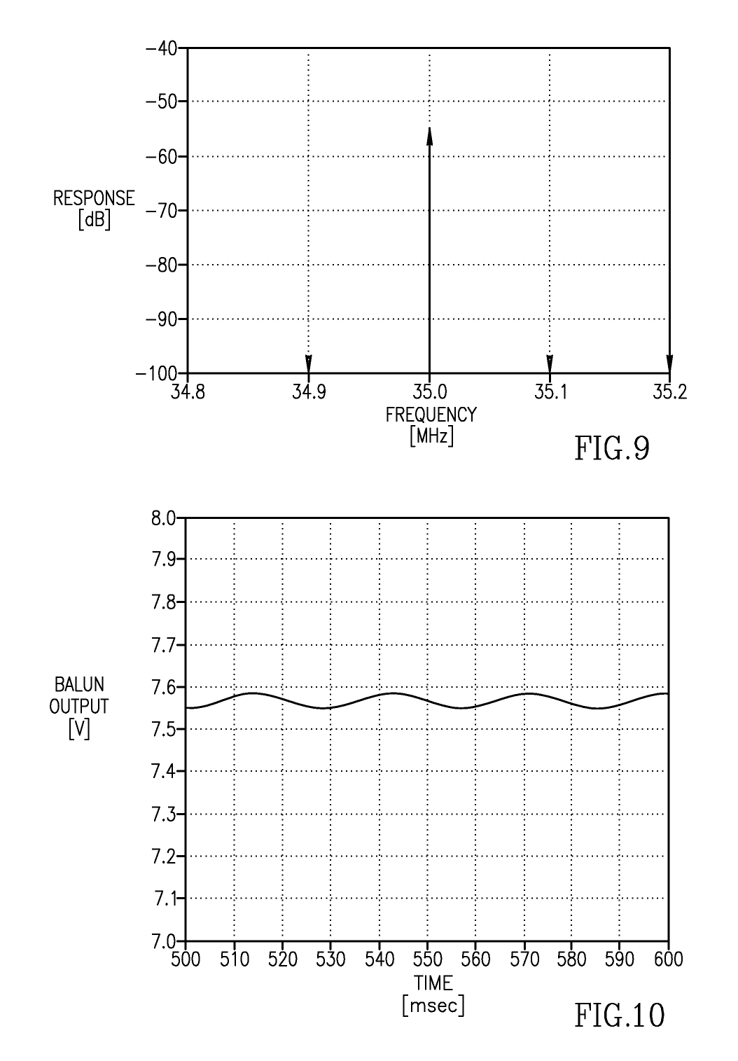

A time domain plot of the spur without the spur cancellation mechanism of the present invention is shown in FIG. 8. The amplitude of the spur is 1.78 μV=20 log₁₀(1.78 μV/0.001 mV)=−55 dBmV. A frequency spectrum of the spur of FIG. 8 is shown in FIG. 9. The amplitude of the spur is −55 dBmV at 35 MHz.

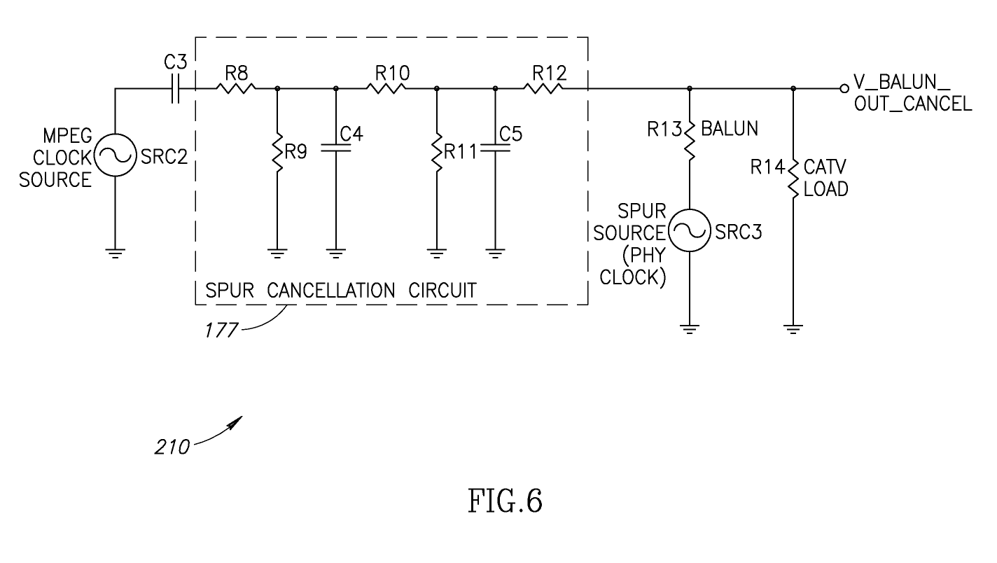

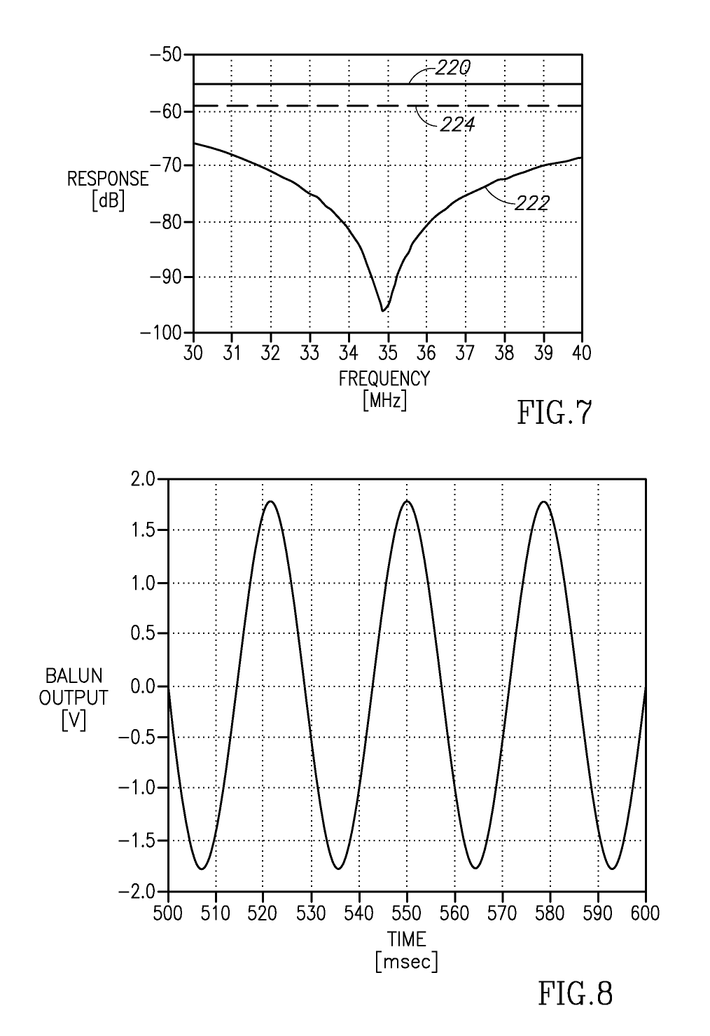

A spectrum plot illustrating frequency response of the spur cancellation circuits of FIGS. 5 and 6 is shown in FIG. 7. The response of the circuit 200 of FIG. 5 (without the spur cancellation mechanism) is measured across resistor R7 (V_BALUN_OUT_NO_CANCEL) and is shown in trace 220. The response is relatively flat at −55 dBmV. Dashed line 224 represents the DOCSIS 2.0 specification for spur level (−59 dBmV, see Table 1). Thus, the response of circuit 200 fails to meet the DOCSIS 2.0 specifications.

A block diagram illustrating a model of a portion of the upstream circuit incorporating the spur cancellation mechanism of the present invention is shown in FIG. 6. The circuit, generally referenced 210, comprises SRC2 (MPEG clock source), coupling capacitor C3, spur cancellation circuit 177, SRC3 (spur source, PHY clock), R13 (balun), R14 (CATV load). The spur cancellation circuit 177 comprises resistors R8, R9, R10, R11, R12, and capacitors C4, C5.

Example values of the resistor and capacitor component values for the circuit 177 are given below in Table 4.

TABLE 4
Example component values

| Component | Value |
|---|---|
| R8 | 100 kOhm |
| R9 | 3500 Ohm |
| R10 | 100 kOhm |
| R11 | 3500 Ohm |
| R12 | 3320 Ohm |
| C4 | 3.9 pF |
| C5 | 3.9 pF |

The value of the coupling capacitor C3 is 100 nF. Resistor R13 represents the impedance of the balun which is 75 Ohm while resistor R14 represents the cable modem load which is 75 Ohm (to maximize power transfer).

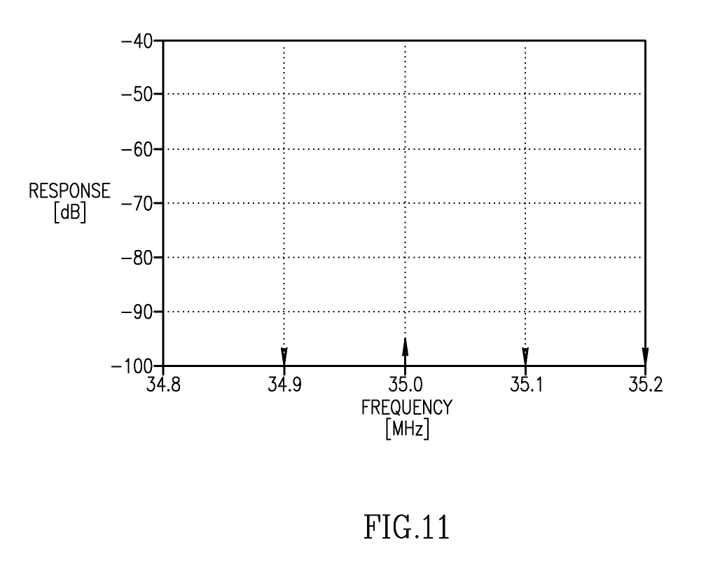

A time domain plot of the spur with the spur cancellation mechanism of the present invention is shown in FIG. 10. The amplitude of the spur is approximately 34 nV=20 log₁₀(34 nV/0.001 mV)=˜−90 dBmV. A frequency spectrum of the spur of FIG. 10 is shown in FIG. 11. The amplitude of the spur is −95.6 dBmV at 35 MHz, which represents an improvement of approximately 40 dB over the circuit without the spur cancellation circuit.

Referring to FIG. 7, the response of the circuit 210 of FIG. 6 (with the spur cancellation mechanism) is measured across resistor R14 (V_BALUN_OUT_CANCEL) and is shown in trace 222. The response is a notch with a minimum at −95.5 dBmV which is an improvement of over 40 dBmV compared to the response of circuit 200 (FIG. 5). Thus, the response of circuit 210 meets the DOCSIS 2.0 specifications. Note that the response of FIG. 7 is the results of a simulation. In actuality, the improvement of circuit 210 with the spur cancellation circuit over the circuit 200 without it may be only −15 to −20 dBmV. Thus, the notch minimum would be at approximately −70 dBmV, still well below the maximum level permitted by the DOCSIS 2.0 specification.

### Second Embodiment: RF Switch Circuit

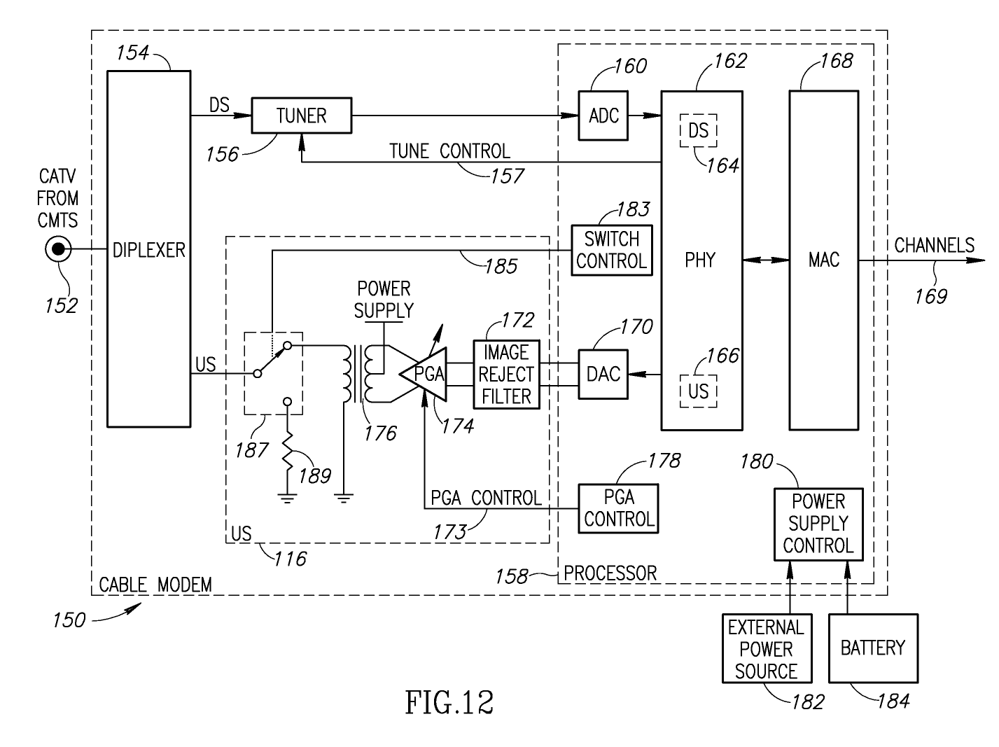

A simplified block diagram illustrating the processor of the cable modem of FIG. 2 including an upstream system incorporating a second embodiment of the spur reduction mechanism of the present invention is shown in FIG. 12. The example cable modem, generally referenced 150, comprises diplexer 154 coupled to a CATV input 152, RF tuner circuit 156, processor 158 and upstream path circuit 116.

The upstream circuit 116 comprises image reject filter 172, PGA 174, balun 176 and RF switch 187. The processor 158 comprises an analog to digital converter (ADC) 160, PHY circuit 162, digital to analog converter (DAC) 170, PGA control circuit 178, switch control circuit 183, power supply control 180 and MAC 168. Power is supplied by an external power source 182 e.g., utility power, etc. or a battery 184.

In operation, in the downstream (i.e. receive) direction, the receive signal from the diplexer is input to the CATV RF tuner circuit 156. The tuner output signal is input to the ADC to provide I and Q input signals to the PHY circuit. The PHY circuit provides a tuner control signal 157 that controls the tuning of the tuner circuit. After MAC processing, one or more MPEG video streams 169 are output of the cable modem.

In the upstream (US) (i.e. transmit) direction, a digital TX output signal provided by the PHY circuit is converted to analog by the DAC. The analog signal is then filtered via the image reject filter 172 before being amplified by the PGA whose gain is controlled by a PGA control signal 173 generated by the PGA control circuit 178.

The output of the PGA circuit is input to one side of the balun 176. The other side of the balun is input to a single pole double throw (SPDT) RF switch 187. One terminal of the switch is coupled to the output of the balun while the other terminal is connected to ground via 75 Ohm resistor 189. The output of the RF switch is input to the diplexer 154 which couples the US signal to the CATV cable 152.

In accordance with the invention, the RF switch 187 functions to eliminate in-band spurious emissions from the US signal before input to the diplexer. The second embodiment is based on a wide band isolation RF switch which limits the 35 MHz spur and any additional spurs from leaking to the RF output of the cable modem in between transmission bursts.

An example RF switch suitable for use with the present invention is the AS211-334, PHEMT GaAs IC SPDT Switch, manufactured by Skyworks, Woburn, Mass., USA. The RF parameters, including linearity, insertion loss and switching performance make this RF switch suitable for use in the example circuit presented herein. It is appreciated that other components with similar parameters may be used.

In this example circuit, the RF switch is controlled by a switch control signal 185 generated by the switch control circuit 183 internal to the processor 158. The switch control circuit is operative to couple the output of the balun to the diplexer during transmission bursts and to the resistor coupled to ground in between transmission bursts.

Note that this second embodiment takes advantage of the relaxed spurious emission levels permitted by the DOCSIS 2.0 during transmission bursts as compared to between bursts (see Tables 1 and 2 presented supra).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1-17. (canceled)

18. A circuit for canceling frequency spurs from a victim signal, said frequency spurs derived from an aggressor clock source, comprising:
a radio frequency (RF) switch having an output and operative to connect and disconnect said victim signal to said output in accordance with a switch control signal; and
a switch control module operative to generate said switch control signal, wherein said victim signal is coupled to said RF switch output during transmission bursts only.

19. The circuit according to claim 18, wherein said RF switch comprises a double pole RF switch operative to connect said output either to said victim signal or ground.

20. The circuit according to claim 18, wherein said RF switch is operative to connect said output to ground between transmission bursts.

21. The circuit according to claim 18, wherein said victim signal comprises a Data Over Cable Service Interface Specification (DOCSIS) upstream (US) signal.

22. The circuit according to claim 18, wherein the signal output of said RF switch sufficiently meets Data Over Cable Service Interface Specification (DOCSIS) 2.0 requirements.

23. A method of canceling frequency spurs from a victim signal, said frequency spurs originating from an aggressor clock source, said method comprising the steps of:
providing a radio frequency (RF) switch having an output and operative to connect and disconnect said victim signal to said output in accordance with a switch control signal; and
generating said switch control signal whereby said victim signal is coupled to said RF switch output during transmission bursts only.

24. The method according to claim 23, further comprises the step of controlling said RF switch to connect said output to ground between transmission bursts.

25. A cable modem connected to a Community Antenna Television (CATV) infrastructure, comprising:
a memory;
one or more interface ports;
a downstream path including a tuner;
an upstream path for generating an upstream signal to be transmitted over said CATV infrastructure, said upstream path including a radio frequency (RF) switch having an output and operative to connect and disconnect said upstream signal to said output in accordance with a switch control signal;
a PHY circuit coupled to said tuner and said RF switch, said PHY circuit comprising a switch control module operative to generate said switch control signal, wherein said upstream signal is coupled to said RF switch output during transmission bursts only; and
a processor coupled to said memory, said one or more interface ports and said PHY circuit, said processor operative to implement a media access control (MAC) layer operative to generate an output video stream.
